(19) United States
(12) Patent Application Publication
(10) Pub. No.: US 2019/0377330 A1
(43) Pub. Date: Dec. 12, 2019

(54) Augmented Reality Systems, Methods And Devices

(71) Applicant: Praxik, LLC, Clive, IA (US)

(72) Inventors: Luke Shors, Minneapolis, MN (US); Aaron Bryden, Minneapolis, MN (US)

(21) Appl. No.: 16/425,441

(22) Filed: May 29, 2019

Related U.S. Application Data
(60) Provisional application No. 62/677,214, filed on May 29, 2018.

(51) Int. Cl. G05B 19/4155; G05B 19/4097; G06K 9/00; G06T 19/00; G06K 19/06

(52) U.S. Cl. CPC G05B 19/4155; G05B 19/4097; G06K 19/06037; G06T 19/006; G06K 9/00275; G06K 9/00671

(57) ABSTRACT

The disclosed apparatus, systems and methods relate to systems, methods and devices for augmented reality (AR) devices and scan overlays for use in myriad applications, such as in industrial and power point applications These implementations involve the use of scanning devices for recording data for later access via tags distributed around an environment, such as an industrial facility or power plant.

### CROSS-REFERENCE TO RELATED APPLICATION(S)

This application claims the benefit under 35 U.S.C. § 119(e) to U.S. Provisional Application 62/677,214, filed May 29, 2018, and entitled “Industrial Augmented Reality Systems, Methods, and Devices,” which is incorporated herein by reference in its entirety for all purposes.

### FIELD OF THE INVENTION

The disclosure relates to various systems, methods, devices and associated techniques and approaches for improving the reliability of augmented reality applications in industrial and other settings.

### BACKGROUND OF THE INVENTION

The concept of augmented reality (“AR”) relates to applications wherein the AR serves to superimpose a computer-generated image or graphical user interface (“GUI”) onto a user's view of the real world—or a representation of that real world—thus providing a composite view.

There are a number of challenges in utilizing augmented reality applications in certain precision environments. These include, for example: limitations in scan volume, because the scanning volumes used to enable many AR applications are insufficient for scanning large spaces; specific environmental characteristics of various industrial and commercial settings such as extreme temperatures, loud noises, vibrations, lighting conditions, different material surfaces, and strong magnetic fields—all of which may disrupt AR and device localization approaches. Additionally, multiple instances of identical or nearly identical equipment and/or variations in the normal visual characteristics of equipment over visits (i.e. changes in valve position, state of components, etc.) or the current set of installed equipment can limit the ability to use feature-based mapping approaches or other approaches dependent on visual tracking. Moreover, specific safety issues, arising from various conditions such as confined spaces, may thwart certain image matching approaches or visual overlay approaches, as the device may be too close to the object of interest.

In addition, the critical nature of many industrial activities requires a degree of precision and certainty in AR applications that may exceed requirements for consumer applications.

### BRIEF SUMMARY

There is a need in the art for AR approaches that are effective, precise, and reliable. Described herein are various embodiments relating to devices, systems and methods for AR. Although multiple embodiments, including various devices, systems, and methods of utilizing augmented reality and augmented reality scanning, and are described herein as a “system,” this is in no way intended to be restrictive.

The disclosed embodiments employ scanning techniques for capturing large industrial spaces along with visual and device tracking with a recognition procedure consisting of one or more tags that collectively enable highly-reliable augmented reality applications in industrial settings or other environments where enhanced precision and reliability are required.

In various applications, AR may provide an extremely intuitive interface for users accessing or inputting the information in industrial settings or other precision environments. In various embodiments, the disclosed AR systems can go beyond specific physical entity identification enabled by labels, barcodes, and QR codes through spatially-linking dynamic graphics and holograms to the physical equipment. In one example, a holographic guide could step an operator through a specific process or procedure visually, in addition to or instead of merely linking to the appropriate textual information or weblink via a QR code associated with a unique physical entity.

In various Examples, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One Example includes an augmented reality system, including a scanning device constructed and arranged to generate scan data, one or more tags disposed within an environment, a storage medium in communication with the scanning device, and a display in communication with the storage medium. The augmented reality system also includes where one or more tags are scanned by the scanning device. The augmented reality system also includes where scanning data is generated and stored in the storage medium. The augmented reality system also includes an augmented reality overlay that is displayed on the display. Other embodiments of this Example include corresponding computer systems, apparatus, and computer programs recorded on one or more computer storage devices, each configured to perform the actions of the methods.

Implementations may include one or more of the following features. The system where at least one of the one or more tags is a QR code. The system where the storage medium is a database. The system where the environment is a power plant. The system where the environment is a hospital or medical clinic. The system where the augmented reality overlay includes patient medical data. The system where at least one of the one or more tags is a face of a patient. Implementations of the described techniques may include hardware, a method or process, or computer software on a computer-accessible medium.

One Example includes a system, including a device, one or more tags disposed within an environment, and a storage medium including scan data for the environment, where the device scans the environment and the one or more tags, the device validates the scan and retrieves the corresponding scan data from the storage medium, and an augmented reality image is produced. Other embodiments of this Example include corresponding computer systems, apparatus, and computer programs recorded on one or more computer storage devices, each configured to perform the actions of the methods.

Implementations may include one or more of the following features. The system where the AR image is spatially anchored. The system where a user can interact with the AR image. The system where the device uses tracking and recognition of the one or more tags to validate a scan. The system where the device is remotely controlled. The system where the augmented reality image is remotely viewed. The system where the environment is an industrial plant. Implementations of the described techniques may include hardware, a method or process, or computer software on a computer-accessible medium.

One Example includes a method for viewing an environment, including generating a scan of an environment including one or more tags, retrieving data corresponding to the environment and the tags from a storage medium, viewing an augmented reality overlay on the environment. Other embodiments of this Example may include corresponding computer systems, apparatus, and computer programs recorded on one or more computer storage devices, each configured to perform the actions of the methods.

Implementations may include one or more of the following features. The method where at least of the one or more tags is a patient code. The method where another of the one or more tags is a face of a patient. The method where the data includes medical data. The method further including designating variable and fixed regions. The method further including detecting changes within the environment. Implementations of the described techniques may include hardware, a method or process, or computer software on a computer-accessible medium. In one Example, a system utilizes a tag or tags to establish and select an augmented reality environment scan used for tracking and other purposes, such as occlusion as found in commercially-available products understood in the art. For instance, on the Microsoft Hololens® the barcode recognition would use the WorldAnchorTransferBatch class to load a set of augmented reality spatial anchors that match the current localized environment. This would enable the Hololens® to recognize the local environment.

In another Example, the system includes Bluetooth® low energy recognition, WiFi triangulation, GPS, RFID, and/or other non-visual spatial location technologies. The system may include textual recognition of a tag, the tag may be a bar code, QR code, Optical Character Recognition (OCR), RFID, GPS, Bluetooth®, WiFi, facial recognition and the like.

Further Examples of the system may feature use of the combination of visual tracking information and barcode information or tag information to calculate a level of certainty that the right tracking environment is being used and the likely alignment error.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1A is exemplary diagram of the system in use, according to one implementation.

FIG. 1B is a front view of a scanner in use, according to one implementation.

FIG. 1C is a front view of an AR overlay and system in use, according to one implementation.

FIG. 2A is flow chart depicting an AR set-up procedure, according to one implementation.

FIG. 2B is a flow chart depicting a user verification procedure for AR labels, according to one implementation.

FIG. 3A is a front view of the system in use, according to one implementation.

FIG. 3B is a front view of a scanner in use, according to one implementation.

FIG. 3C is a front view of an AR overlay and system in use, according to one implementation.

FIG. 4 is a front view of an AR overlay and system in use, according to one implementation.

### DETAILED DESCRIPTION

The disclosed technology relates to augmented reality and visualization systems, and more specifically, to devices, systems and methods for collecting, storing and accessing spatial and other forms of information for augmented reality overlays and other types of spatial processing. The various implementations described herein can be used in conjunction with U.S. application Ser. No. 15/631,928, entitled “Cryptographic Signature and Related Systems and Methods,” filed Jun. 23, 2017 and U.S. application Ser. No. 15/331,531, entitled “Apparatus, Systems and Methods for Ground Plane Extension,” filed Oct. 21, 2016, both of which are incorporated by reference in their entirety for all purposes.

One or more computing devices may be adapted to provide desired functionality by accessing software instructions rendered in a computer-readable form. When software or applications are used, any suitable programming, scripting, or other type of language or combinations of languages may be used to implement the teachings contained herein. However, software need not be used exclusively, or at all. For example, some embodiments of the methods and systems set forth herein may also be implemented by hard-wired logic or other circuitry, including but not limited to application-specific circuits. Firmware may also be used. Combinations of computer-executed software, firmware and hard-wired logic or other circuitry may be suitable as well.

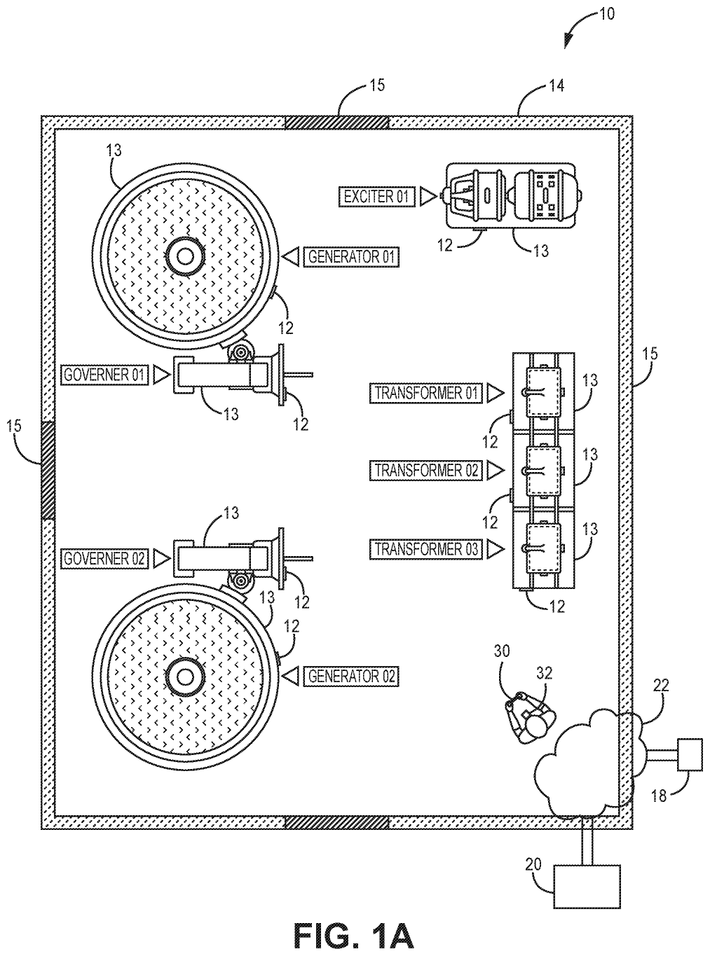

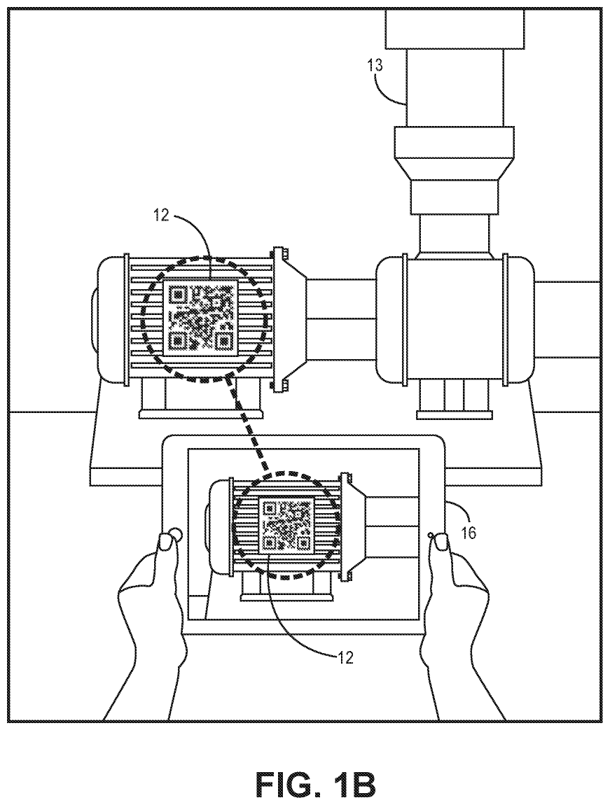

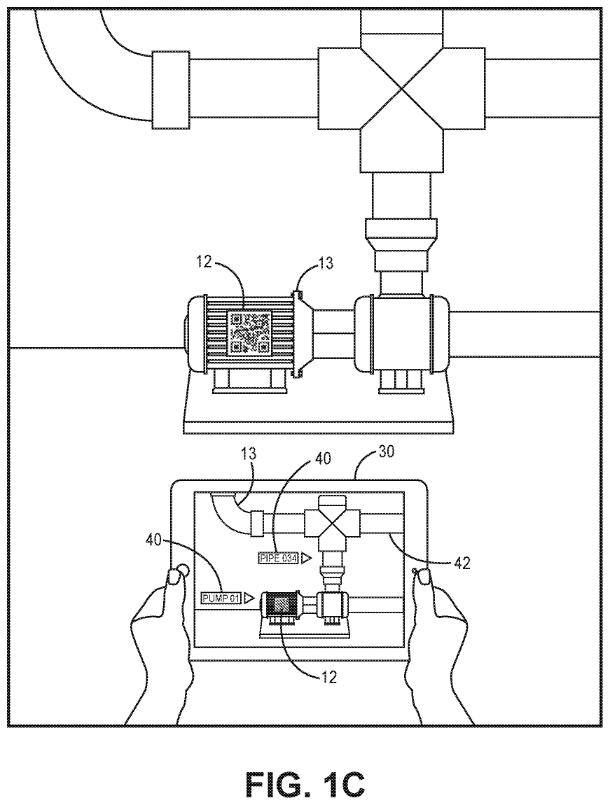

Turning to the drawings, FIGS. 1A-C and 2A-B depict exemplary implementations of the system 10. In these implementations, the system 10 is used to scan and store information about an environment or environments for later access. In various implementations, the scan data can comprise spatial information that can later be accessed or queried to also return various associated information to the augmented reality (“AR”) user. Further implementations and aspects will be apparent from the following disclosure.

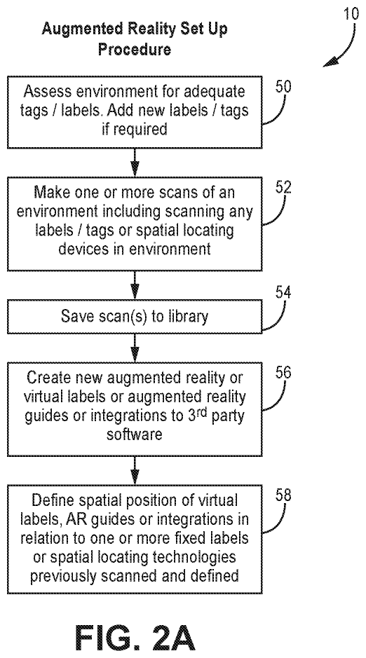

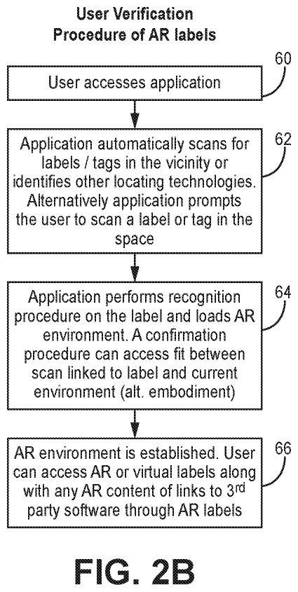

In exemplary implementations of the scanning system 10, one or more signaling devices, or tags 12 are affixed to equipment 13, environment of interest 14 (as shown at box 50 in FIG. 2A), or otherwise disposed within the environment. In certain implementations, these tags 12 can consist of bar codes, characters for OCR, RFID, NFC, QR codes, Bluetooth® beacons, facial recognition, or other technologies known and appreciated by those of skill in the art. In some implementations various tags 12 may already exist in the environment of interest 14—such as on objects, equipment 13 and walls 15—that can be utilized by the system.

In these implementations, and as shown in FIGS. 1A-C and in FIGS. 2A at box 52 and 2B at box 62, a device 30, or scanner 16 is used to generate localized or global scan data of equipment (shown, for example at 13) within the environment of interest 14. In various implementations, the scanner 16 is integral to the device 30 or may be a separate device or devices. The scanner 16 may be software implemented on various devices 30 such as but not limited to an iPad®, the Google® Tango® Platform, the Microsoft® Hololens®, and Occipital® Bridge Engine®.

The scanner 16 takes scans of a desired environment 14 generating scan data which may include the scanning of optical markers and tags 12 in the process. In alternate implementations, various other scans may be used, including laser-based scans and/or blueprints (not shown) for generating scans enabling augmented reality applications. Others would be apparent to those of skill in the art.

In certain implementations, the scanning of a tag 12 may be done actively or passively. In some implementations, a user may be prompted to scan a tag 12 and the application is launched upon scanning of the tag 12. In these and other implementations, after the application is launched scanning for other tags 12 is done passively. In alternative implementations, the device scans for all tags 12 passively. In alternative implementations, one or more tags 12 are scanned actively upon prompting by the system 10 or a user.

As is also shown in FIGS. 1A-C and in FIG. 2A at box 54, in certain implementations, scan data can be saved to a library 20. The scan data can be saved to the library 20 by any known method, such as by a remote computer 18 or other device connected via a network 22, via wires or wirelessly. The scan data can be saved on computer-readable media, as would be readily appreciated. Accordingly, the scan data may be saved into a library 20 of scan data that consists of one or more discrete scans for a particular physical environment 14 or environments. It is understood that networked servers and databases can be constructed and arranged to collect and archive the scan data.

In various implementations, augmented reality overlays 40, augmented reality interfaces, or “buttons” (shown generally by overlays 40) are then generated and spatially anchored to specific points or features on the device 30 displaying a local scan 42 (box 56). It is understood that a user will be able to view and/or interact with the AR overlay 40.

It is understood that in various implementations, the AR overlays 40 may be generated by various devices, methods and systems, as would be recognized by those of skill in the art. In some implementations, an AR overlay 40 is constructed via a graphical user interface and/or display. A user may be prompted to enter data or retrieve data related to the environment scanned for implementation within the AR overlay 40. Various other implementations are of course possible and would be recognized by those of skill in the art.

In certain implementations, as an additional step, the AR overlay 40 can be presented to the user on a device 30 such as a tablet 30 or head-mounted display 32. In these and other implementations the AR overlay 40 may be linked to various menus of interest. In certain aspects, the AR overlay 40 can be used as a conduit for users to enter data, be integrated with other IT systems, and/or support the visual display of other information not shown locally on the physical equipment. These implementations thereby allow for the system 10 to establish an AR environment via the overlay 40 for the user and enable the user to interface with all of the relevant information for a piece of physical equipment 13 or log the condition of the equipment 13.

In use, as shown in FIGS. 1A-1C and FIG. 2B at box 60, to access the AR interface in any given environment, the user 1 orients a device 30 at the desired environment 14 or directs a head-mounted display 32 at the environment 14 or equipment 13. It is understood that although this appears to be a single action from the perspective of the user 1, in the process, the device 30, 32 uses tracking, camera matching, feature-based mapping and the recognition of one or more tags 12 (box 62) to validate the scan (box 64) and retrieve the appropriate scan data from the scan library 20 or the particular portion of a larger scan from the library 20 for AR overlay 40 and establish the AR environment (box 66). The conjunction of these approaches allows the AR interface to be robust in an industrial environment 14. In use, the system 10 can generate the AR overlay with a high level of confidence when combining two or more approaches. For example, the system 10 may use object scanning and QR recognition to retrieve and project the appropriate AR environment.

In various alternative implementations, the user 1 may be a robot, drone, security camera, or other device that is remotely operable. These machine type users 1 may orient on on-board device 30 or other type of integrated scanner 16 to capture scan data and to access the AR interface.

In various implementations, the presently disclosed devices, systems and methods can be used in conjunction with the approaches described in US application Ser. No. 15/331,531, filed Oct. 21, 2016 and entitled “Apparatus, Systems and Methods for Ground Plane Extension,” which is incorporated by reference in its entirety. In one such exemplary implementation, after establishing the device 30 location within a local scan using one or more tags 12, the system 10 can utilize the “found planes” in the scan 40 to extrapolate out planes beyond where the local depth data exists. It is understood that under this approach, the user can set up augmented reality content at any distance from the local scan in a standard environment or space that is defined by uniform planes (walls, floors, ceilings, etc.). Accordingly, this approach allows users to set up AR content 42 throughout a large environment 14 even without having access to a full scan for the entire environment 14.

It is also understood that the use of barcodes or other location tags 12 such as WiFi triangulation or Bluetooth low energy beacons to retrieve the appropriate scan from a library 20 of scans. Use of WiFi triangulation, Bluetooth® beacon, or other tags, in addition to visual tracking can provide a higher degree of certainty for the AR overlay or other visualization than by using visual tracking alone. These implementations of the system provide the necessary confidence in augmented reality access to enable many industrial, clinical, commercial or residential processes to be performed in conjunction with the system 10.

In various implementations, the device 30 may recall the appropriate scan data via location tracking systems provided within the device SDK—such as from Apple®, Google®, or Microsoft®. The device 30 may utilize the location data alone or in conjunction with one or more tags 12 to retrieve and align the AR overlay within the environment. The use of location data provided by the device 30 may allow for more accurate alignment with relatively smaller tags 12 such as barcodes or printed text than larger AR tags 12.

In some implementations, the device 30 may validate the position of a part or the position of AR interface via a combination of global and local tags 12. In various implementations, a global tag 12—such as a barcode—can be scanned by the device 30 to indicate a “global level” location of a device. For example, the global tag 12 may indicate that the device is within a particular plant, address, or other location as would be recognized by those of skill in the art. Local tags 12 may be used to provide multipoint alignment of the AR overlay or interface—such as three point alignment. In these implementations, the local tags 12 may be unique to a location within the plant and help to properly align and orient the AR interface.

The use of multiple tags may additionally increase the accuracy of alignment of an AR overlay within an environment. By orienting the AR overlay using more than one tag the system may be able to determine with higher degree of accuracy the placement and alignment of the AR overlay. This in turn could be used to determine if a particular piece of equipment is or is not where it is supposed to be.

In various implementations, only one tag is used. In these implementations the alignment of the AR overlay may be dependent on the size of the tag relative to the camera, the alignment of the environment, the rotational accuracy of the tag detection, and locating the exact borders of the tag in the viewport of the camera. In various alternative implementations, more than one tag is used and the accuracy of the AR alignment is less dependent on the above factors.

In some implementations, the alignment of the AR interface may be done manually. In various other implementations, the alignment is done via a passive or automatic system. In these and other implementations a wide-angle camera is used.

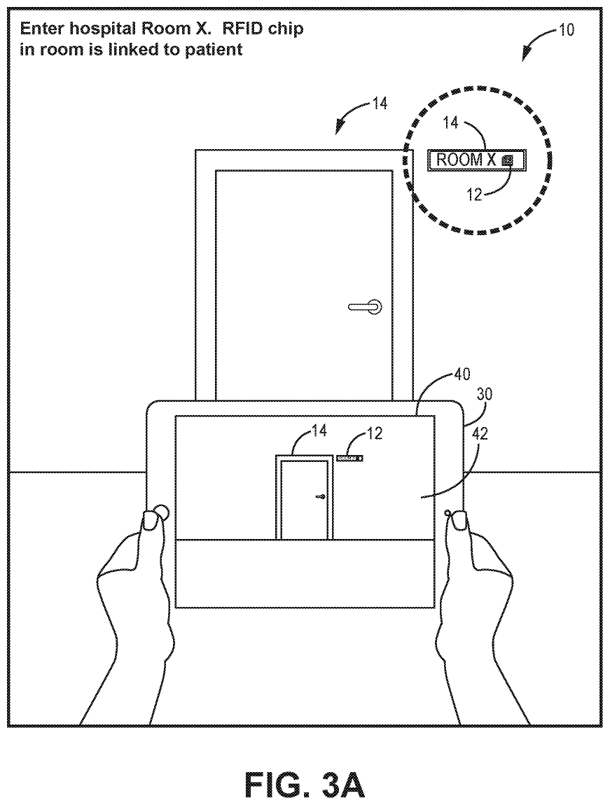

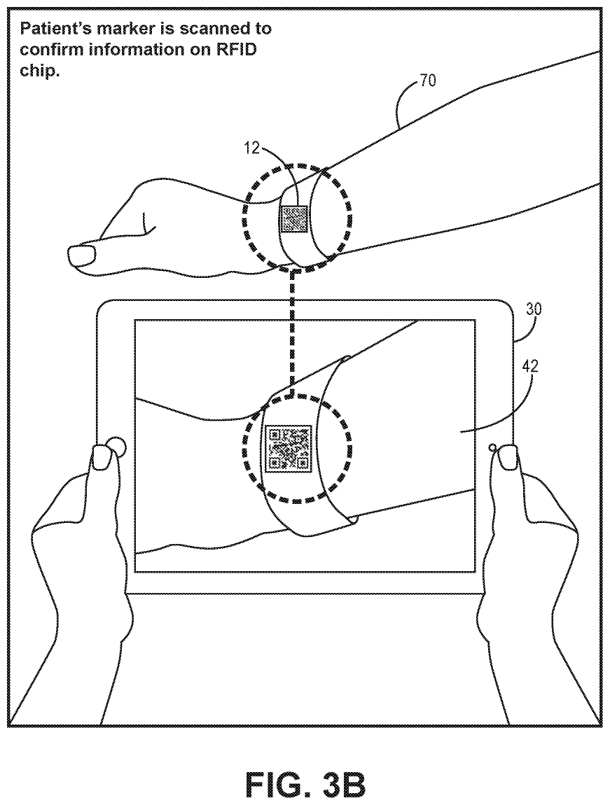

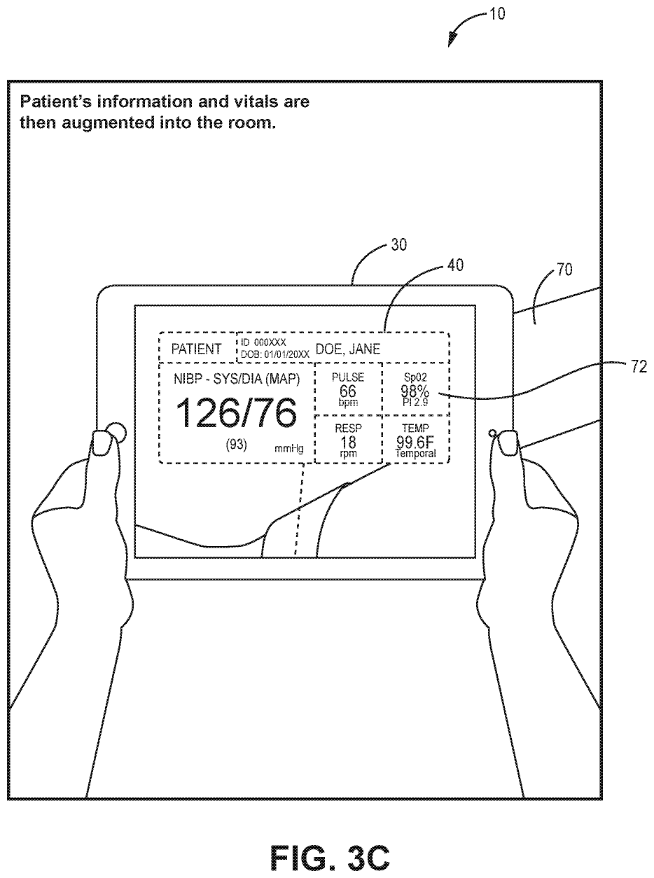

FIGS. 3A-3C depict a further implementation of the system 10 deployed in a clinical setting. In these implementations, the tags 12 may be associated with a physical location 14 such as a hospital room. In these implementations, the tag 12 can allow the device 30 to retrieve information related to the room 14 and patient 70 from a library 20. It is understood that in these implementations, the AR overlay 40 on the device 30 can therefore be used to access patient data 72. Patient data 72 may include real time patient data such as but not limited to blood pressure, pulse, oxygen levels, temperature, and respiratory rate. Various other patient data 72 may be displayed or accessed including data from electronic medical records for the patient 70.

In various other implementations, the tags 12 may include facial recognition. In one specific example, the face of a patient 70 can be scanned at the time they are registering to be an organ donor, such as when getting a driver's license or other identification card. This facial scan can be stored in a library 20 such that at an accident scene the face of the patient 70 can be scanned as a secondary indicator that they are an organ donor in addition to their driver's license.

In another implementation, the face of a patient 70 can be scanned and stored in a library 20 and act as a tag 12 to the medical records of the patient 70. More specifically, the system 10 can scan the patient's face, access their medical records and provide various information regarding the patient 70 such as information about body systems and information relevant to surgery in the form of an AR overlay 40 or AR scene.

As shown in FIGS. 3A-3C the system 10 can be implemented in a clinical setting such that a hospital wristband may contain a tag 12 such as a QR code 12. This tag 12 can be scanned by a device 30 or other scanner 16. The scan may additionally include the patient's 70 face (not shown) as a secondary tag 12. The facial recognition may be used to confirm that the correct QR code or other tag 12 was assigned to the patient 70.

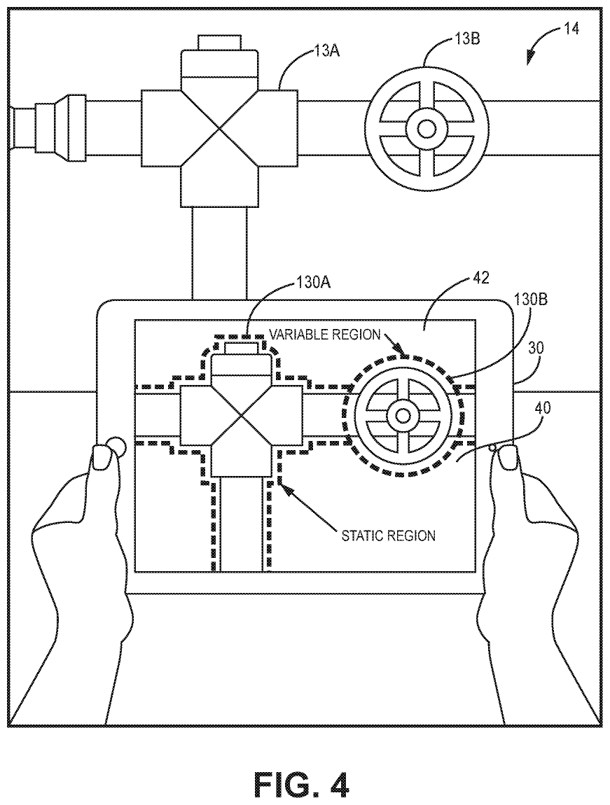

In further implementations, the system 10 account for anticipated and unanticipated alterations in the physical environment 14 in the scanning process. As is shown in FIG. 4, and as would be understood, some aspects of an environment are not fixed. For example, various pieces of equipment, (hereinafter “variable regions”) such as the wheel 13B shown in FIG. 4, can move. In these implementations, an administrator can specify—during the scanning process—the fixed regions 13A and variable regions 13B of the environment 14. For instance, while performing the 3D scanning an administrator could segment the scanning volume into regions that were largely fixed or more variable based on the day-to-day operations of the particular environment. Accordingly, in use, the user interface provides the user that ability to define the corresponding fixed 130A and variable 130B regions of the rendered environment.

Alternatively, these variable regions 13B of scanned environments 14 can be detected automatically after multiple scans. For example, when a region is scanned multiple times and there are differences between the multiple scans the variable region may be detected and labeled as such. As a further alternative, these variable regions 13B could be detected automatically in new scans using knowledge of previous scans and machine learning—for instance labeling moving parts (either manually or automatically using subsequent scans) and using convolutional neural networks to identify fixed, moving, and movable equipment. It is understood that using similar approaches it is possible to identify fixed environment features (such as walls 14 or fixed equipment 13A) as opposed to variable fixtures (equipment 13B).

In certain applications, the variable regions, visual features, visual alignments or other location identifiers that rely on these regions can be independently—or collectively—used to determine a location match. These regions can likewise be used for appropriately overlaying augmented reality content on variable regions. For instance, these environmental characteristics used in tracking or locating a device location could be excluded all together if they were tied to a piece of mobile equipment, or in the case of a piece of equipment that can move in a constrained manner or is likely to move in a constrained manner, these constraints could be used to provide a search space of these environmental characteristics or features.

Additionally, various physical constraints can arise from physical limitations in the environment 14 or the impact of regulations or any other reason such as human psychology, aesthetic preferences or a range of other possibilities that would be understood in the specific application. In certain implementations of the system, the constraints can be determined using principal component analysis, eigenvector decomposition or another mathematical approach to take a set of exemplars and turn that set into a maximally likely set of directions in the n-dimensional space of possible configurations where the likely n is recovered automatically. Each of these approaches support not only correctly identifying the appropriate scan from the scan library 20 but the proper alignment of the holographic markers on both the fixed and variable aspects of industrial environments.

In various implementations, once mathematical representations of the likely configuration space 14 of environments and equipment 13 are established, it is understood that in certain aspects, the system is can be configured to detect outliers that do not fit a likely space in the model and automatically flag them. This could be used for safety and security purposes as well as to support fine-grained, historical information about the configuration of physical spaces. For instance, the current position of a piece of equipment could be attributed to a particular change in the scan or a change in the environment which could be attributed to a particular piece of work that was performed.

In one specific example, the system 10 can be implemented as part of a security protocol. A security camera or other type of scanner 16 can routinely sweep an environment 14 and compare the current scan to a previous and/or a model scan of the environment 14. The system 10 can then identify the variable regions 13B of the environment, such that changes within those areas would not be detected as security risks. While if changes are detected in fixed regions 13A the system 10 could issue an alert or other type of signal to a user to indicate the change. These and other implementations, may be used for sweeping for bombs by cameras, drones and robots.

In another embodiment, this fine-grained historical information about physical spaces could be used to verify that a piece of work did not impact the compliance of safety regulations or trace why a safety regulation was violated and who was responsible.

In another embodiment, after performing the initial scan, subsequent images can be spatially linked to specific locations within the environment. The user could be directed to take photos or further scans that match the perspective and viewpoint of previous photos or scans more closely.

In another embodiment, after taking an initial scan or scans, scan data could be gathered passively either with or without a depth camera. These subsequent scans could be used to update historical information about the space and provide fine-grained historical data.

Furthermore, various implementations can support or otherwise impose user-defined constraints on physical aspects of a setting. In one illustrative example, walkways can be defined as needing to be clear of obstacles, which then could be identified and flagged. Any change can be highlighted automatically if present. It would also be possible to flag movement of an object by a user in violation visually in an AR interface for the user so they catch it immediately.

In other embodiments, custom computer vision around optical markers improves the recognition of markers or tags and other nearby features. For instance, a user might start a scan or AR session from a viewpoint where a marker is fully in view and use the known marker to align with the 3D structure of a scan. Then based on this information a transformation to camera signal used in the original visual scan to match the current lighting conditions could be computed. This would then give a greater likelihood of aligning the rest of the space with the visual marker. Alternatively, an entirely new visual scan could be generated, while previous information is aligned with the marker and old scan could be used with the new scan.

The system 10 could recognize the presence of a tag along with the known accuracy of the position of the camera and the tag. This can be used to determine where in a scan to search and used with feature mapping or other mapping techniques relate current lighting conditions in the environment. For instance, knowing with a high degree of confidence that a marker is in the field of view of a camera or device 30 may allow the 3D structure of an environment to be rendered, that was scanned previously, to be used in new lighting conditions.

These and other implementations allow for rebuilding the visual tracking information in the new lighting conditions automatically based on both the knowledge of the marker recognition and the 3D model. With the previously known 3D model of a space and the tag 12 recognition, it is possible to know where a device is in relation to the 3D environment and therefore include a visual environment, such as AR. These implementations may also include altering the visual characteristics of the augmented reality content to stand-out in relation to the new lighting conditions of the environment.

In an exemplary implementation, the system 10 is able to use the AR interface enabled as a visual tool for accessing Internet of Things-type (IoT) devices in the vicinity, as would be understood by one of skill in the art. In this embodiment, the IoT devices are visually represented in the scanning process and the information and the interfaces available through those devices are be accessed through the AR interface. The data from these IoT devices can represent an additional source triangulation and verification for the scan.

In another embodiment, the system is constructed and arranged to use the local environment to contextualize accessing appropriate elements of what are known in the art as “big data” systems. For instance, if there is monitoring data related to an AR view—or near the AR view—the user may want to access the data or associated analytics. Knowledge and recognition of what a user or system is viewing may be useful when predicting what information a user might want or need to access. This may be useful in constructing a query within an environment. For instance, what a user is interacting with, what task a user is engaged with, or what is nearby may help optimize the rank order of relevant pieces of data or analyses. By tracking what a user looks for or interacts with when interacting with scans or the system—out in the field, live AR, or as part of a work order generation—can support the optimization of information as part of the system 10.

In another implementation, tags 12 can be added within a software modeling package. In these and other implementations, the tags 12 are added via a plugin to well-known programs such as SketchUp or Revit. For example, in use, a user such as an architect or designer is able to link tags 12 to parts of the model as part of the modelling process. In various implementations, the tags 12 can be selected from a menu of QR codes that could be assigned to parts of the model. For example, a specific QR code can be assigned to the northwest corner of the building, a north-facing wall, and other areas or parts as would be appreciated. These assigned tags 12 are recorded within the system 10.

In these implementations, a user can then add corresponding physical tags 12 within the actual as-built environment or space. These implementations allow for correspondence in the tagging between the model and the actual as-built structure.

Further, in these implementations it is possible to overlay the model on the as-built structure, such that the architect or builder is able to “see” how the model conforms to the structure, or vice versa. These implementations may be applied across a broad range of activities. For instance, at a construction site, the system 10 could allow construction workers to see the plans for piping, electrical or duct work in an augmented reality view, spatially anchored to the as-built environment. Use of an AR overlay and the disclosed system 10 allows for double-checking the proposed renovation against the as-built environment, planning a job task, and helping to describe the vision for the space to a prospective client or stakeholder.

The dual tagging procedure, described above, in the software package and physical tagging could expedite the AR experience within the space. Additionally, dual tagging may add a layer of reliability that would be difficult to achieve through standard spatial mapping or feature-based mapping—especially in an environment such as an active construction site with changing physical conditions. In these and other implementation, initial manual alignment or calibration of the overlay may be required—for instance, aligning where the walls meet on the overlay versus the as-built.

In some implementations, the system 10 could require three-point alignment. In one example, the system 10 requires scanning of a patient's face, a tag on the side of the bed, and another tag facing up on the bed. The use of these three different tags or recognitions provides a high-quality alignment.

Although the disclosure has been described with reference to various implementations, persons skilled in the art will recognize that changes may be made in form and detail without departing from the spirit and scope of the disclosed apparatus, systems and methods.

What is claimed is:

1. An augmented reality system, comprising:
(a) a scanning device constructed and arranged to generate scan data;
(b) one or more tags disposed within an environment;
(c) a storage medium in communication with the scanning device; and
(d) a display, in communication with the storage medium,
wherein:
one or more tags are scanned by the scanning device;
scanning data is generated and stored in the storage medium; and
an augmented reality overlay is displayed on the display.

2. The system of claim 1, wherein at least one of the one or more tags is a QR code.

3. The system of claim 1, wherein the storage medium is a database.

4. The system of claim 1, wherein the environment is a power plant.

5. The system of claim 1, wherein the environment is a hospital or medical clinic.

6. The system of claim 5, wherein the augmented reality overlay includes patient medical data.

7. The system of claim 6, wherein at least one of the one or more tags is a face of a patient.

8. An augmented reality system, comprising:
(a) a device;
(b) one or more tags disposed within an environment; and
(c) a storage medium comprising scan data for the environment;
wherein:
(i) the device scans the environment and the one or more tags;
(ii) the device validates the scan and retrieves corresponding scan data from the storage medium; and
(iii) an augmented reality image is generated.

9. The system of claim 8, wherein the AR overlay is spatially anchored.

10. The system of claim 9, wherein the AR overlay is constructed and arranged for user interaction.

11. The system of claim 10, wherein the device is constructed and arranged for tracking and/or recognition of the one or more tags to validate a scan.

12. The system of claim 11, wherein the device is remotely controlled.

13. The system of claim 12, wherein the generated augmented reality image is remotely viewable.

14. The system of claim 13, wherein the environment is an industrial plant.

15. A method for viewing an environment, comprising:
generating a scan of an environment comprising one or more tags;
retrieving data corresponding to the environment and the tags from a storage medium;
viewing an augmented reality overlay on the environment.

16. The method of claim 15, wherein at least of the one or more tags is a patient code.

17. The method of claim 16, wherein another of the one or more tags is a face of a patient.

18. The method of claim 17, wherein the data comprises medical data.

19. The method of claim 15, further comprising designating variable and fixed regions.

20. The method of claim 15, further comprising detecting changes within the environment.
